(19) United States
(12) Patent Application Publication
(10) Pub. No.: US 2009/0188011 A1
(43) Pub. Date: Jul. 23, 2009

(54) TWEEZERS SYSTEM FOR SCANNING PROBE MICROSCOPE, SCANNING PROBE MICROSCOPE APPARATUS AND METHOD OF REMOVING DUST

(76) Inventor: Masatoshi Yasutake, Chiba-shi (JP)

Correspondence Address: Brinks Hofer Gilson & Lione/Seiko Instruments Inc., P.O. Box 10395, Chicago, IL, 60611, US

(21) Appl. No.: 12/355,365

(22) Filed: Jan. 16, 2009

(30) Foreign Application Priority Data
Jan. 22, 2008 (JP) JP2008-011503

(51) Int. Cl. G12B 21/00

(52) U.S. Cl. 850/52

(57) ABSTRACT

To enable to freely interchange a front end shape of a work in accordance with an object of, for example, removing a dust or the like, in addition thereto, even in a case of contaminating a work, to be able to easily deal therewith, and to be able to recognize a defect even when, for example, operated by an operator of a beginner without being governed by a technique of the operator, a tweezers constituted by two arms having probes arranged opposedly to a sample integrated to a scanning probe microscope and constituting an object of observation or working respectively at front ends thereof, and a plurality of kinds of interchanging works one of the plurality of kinds of which is selectively grasped by the tweezers are provided. As the interchanging works, there are an observing stylus work, a work for a contact hole, a corner moving work, a cutting work, a spatula shape work.

### RELATED APPLICATIONS

This application claims priority under 35 U.S.C. § 119 to Japanese Patent Application No. JP2008-011503 filed on Jan. 22, 2008, the entire content of which is hereby incorporated by reference.

### BACKGROUND OF THE INVENTION

1. Field of the Invention

The present invention relates to a tweezers system for a scanning probe microscope utilized when a defect of a sample of a circuit pattern or the like of a semiconductor apparatus is observed, or the defect is corrected, a scanning probe microscope apparatus having the system, and a dust removing method of removing a dust on a sample by using the scanning probe microscope.

2. Description of the Related Art

In recent years, by a progress in a nanotechnology, an advanced technology of a small region of a nanomachine, an electronic device, a memory or the like attracts attention and promotion of a working technology thereof is requested. As one of the microworking means, a method of using a scanning probe microscope (SPM) attracts attention. Although the scanning probe microscope does not reach a working technology of mass production as in a semiconductor process, the apparatus per se is an apparatus having a high working accuracy of nanoscale although the apparatus is simple and at a comparatively low price. Therefore, attention is attracted to that the apparatus is used in a technology of trially fabricating a fundamental device in a high density memory, nanoelectronics, and a nanomachine or the like of next generation, or correcting a mask or the like.

As a technology of utilizing a scanning probe microscope, for example, there is proposed a method of removing a dust adhered to a circuit board in steps of forming a circuit pattern of a semiconductor apparatus by using a tweezers of nanometer order attached to a scanning probe microscope (refer to, for example, JP-A-2007-298587).

According to the method of removing the dust by using the tweezers of the nanometer order attached to the scanning probe microscope, there is achieved an advantage of capable of removing the dust without destructing a miniaturized mask without damaging the mask and while reducing a number of times of cleaning by directly grasping dust on the mask by the tweezers.

However, the following problem remains.

There poses a problem that there is brought about a dust which cannot be removed depending on a shape of a mask, a position of adhering the dust and a shape thereof or the like.

That is, when the dust is solidly adhered to the mask, by simply grasping to pull the dust, there is also a case of destructing the dust in the midst and it is difficult to remove the dust from a root thereof. Further, when a shape of a dust is in a powder state, grabbing by tweezers per se is difficult. Further, when a dust invades inside of a groove, a front end of a tweezers cannot invade inside of the groove, in this case, there poses a problem that removal of the dust is obliged to be abandoned.

Further, when the front end of the tweezers is contaminated in the operation, there also poses a problem that a total of the tweezers needs to be interchanged.

### SUMMARY OF THE INVENTION

The invention has been carried out in view of the above-described situation and it is an object thereof to provide a tweezers system for a scanning probe microscope, a scanning probe microscope apparatus and a method of removing a dust, in which a shape of a front end of a work can be freely interchanged in accordance with an object (for example, removal of a dust or the like), in addition thereto, even a case of contaminating the work can be easily dealt with.

In order to resolve the above-described problem, a tweezers system for a scanning probe microscope of the invention comprises a tweezers comprising two arms having probes arranged opposedly to a sample and integrated to a scanning probe microscope and constituting an object of observation or working respectively at front ends thereof, and a plurality of kinds of interchanging works one of the plurality of kinds of which is selectively grasped by the tweezers.

According to the invention, in accordance with a content to be operated, for example, in a case of an operation of removing a dust, depending on a situation of adhering a dust, a shape of a dust per se or the like, an optimum one of a plurality of kinds of interchanging works is selected to be integrated to the tweezers, thereby, an operation can efficiently be progressed. Further, when the interchanging work is contaminated in the operation, by only interchanging the interchanging work to other interchanging work, harm of contamination can be prevented.

According to the tweezers system for a scanning probe microscope of the invention, it is preferable that as the plurality of kinds of interchanging works, there are provided at least two kinds of interchanging works of an observing stylus work to be scanned along a surface of the sample, a work for a contact hole of raking out a dust at inside of a contact hole of the sample, a corner moving work of moving the dust disposed at a corner portion of the sample, a cutting work of cutting the dust adhered to the sample, and a spatula shape work of moving the dust disposed at a groove of the sample.

In this case, in an operation of removing a dust, an optimum one of a plurality of kinds of interchanging works, for example, the observing stylus work, the work for a contact hole, the corner moving work, the cutting work, or the spatula shape work can be selected, and the operation can be dealt with specifically in accordance with a situation of adhering the dust, the shape of the dust per se or the like.

According to the tweezers system for a scanning probe microscope of the invention, it is preferable that an engaging projected portion is provided at one of portions of the tweezers and the interchanging work brought into contact with each other and an engaging recess portion is provided at to the other, and by engaging the engaging projected portion and the engaging recess portion, when the interchanging work is grasped by the tweezers, positioning of the engaging projected portion and the engaging recess portion is carried out.

In this case, by engaging the engaging projected portion provided at one of portions of the tweezers and the interchanging work brought into contact with each other and the engaging recess portion provided at the other, positions of the tweezers and the interchanging work relative to each other are always determined constant. Thereby, an operation by the interchanging work is facilitated by only inputting the positional relationship previously to a control portion of the scanning probe microscope as data.

According to the tweezers system for a scanning probe microscope of the invention, it is preferable that the engaging projected portions or the engaging recess portions respectively provided at base end sides thereof and operating portions provided at front end sides thereof for carrying out observation or working by being brought into contact with a sample are set to the same positional relationship.

In this case, when the interchanging work grasped by the tweezers is interchanged, positions of an operating portion of the interchanging work before having been interchanged and an operating portion of the interchanging work after having been interchanged become the same position, and therefore, regardless of whether the work is interchanged, an operation of using the interchanging work is further facilitated.

According to the tweezers system for a scanning probe microscope of the invention, it is preferable that the tweezers system further comprises a work holding base having a guide portion holding the interchanging work at a predetermined position and guiding the tweezers such that the engaging projected portion and the engaging recess portion are engaged with each other when the tweezers is proximate thereto.

In this case, when the interchanging work held by the work holding base is attached to the tweezers, the tweezers can be made to reach a position capable of engaging with the interchanging work by being guided by the guide portion of the work holding base. In this way, the tweezers can be positioned to a position automatically engageable with the interchanging work previously held at a predetermined position of the work holding base, as a result, an operation of grasping the inserting work by the tweezers is facilitated.

In order to resolve the problem, a scanning probe microscope apparatus of the invention comprises the tweezers system for a scanning probe microscope described above.

According to the invention, an effect similar to that of the tweezers system for a scanning probe microscope is achieved.

A method of removing a dust of the invention is a method of removing a dust of removing a dust on the sample by using the scanning probe microscope apparatus described above, the method comprises a step of observing a shape of a predetermined area of the sample by the tweezers or the interchanging work attached to the tweezers, a step of determining the interchanging work suitable in working the sample from an observation image acquired by the step and attaching the interchanging work to the tweezers, and a step of removing the dust on the sample by working the sample by the attached interchanging work.

According to the invention, the operation is carried out by attaching the optimum interchanging work to the tweezers in accordance with the shape of the sample observed, and therefore, the dust can efficiently be removed.

According to the invention, by selecting the optimum one of the plurality of kinds of the interchanging works in accordance with the operating content to integrate to the tweezers, the operation can be progressed efficiently. Further, when the interchanging work is contaminated in the operation, it is not necessary to interchange all of the tweezers but by only interchanging the interchanging work used to another interchanging work, harm of contamination can be prevented.

### BRIEF DESCRIPTION OF THE DRAWINGS

FIG. 1 is a perspective view showing an outline constitution of a scanning probe microscope apparatus of an embodiment according to the invention;

FIG. 2 is a perspective view showing a structure of a tweezers of the scanning probe microscope apparatus;

FIG. 3 is a sectional view showing a relationship between the tweezers and an interchanging work of the scanning probe microscope apparatus;

FIG. 4 is a sectional view showing the relationship between the tweezers and the interchanging work of the scanning probe microscope apparatus from other direction;

FIG. 5A is a plane view of an observing stylus work, and FIG. 5B is a side view of the observing stylus work;

FIG. 6A is a plane view of a work for a contact hole, and FIG. 6B is a side view of the work for the contact hole;

FIG. 7A is a plane view of a corner moving work, and FIG. 7B is a side view of the corner moving work;

FIG. 8 is a perspective view for explaining an operation of the corner moving work;

FIG. 9A is a plane view of a cutting work, and FIG. 9B is a side view of the cutting work;

FIG. 10A is a plane view of a spatula shape work, FIG. 10B is a side view of the spatula shape work, and FIG. 10C is a side view of enlarging a front end of the spatula shape work;

FIG. 11A is a plane view of a work holding base, and FIG. 11B is a sectional view of the work holding base;

FIG. 12 is a flowchart for explaining a method of removing a dust on a sample by the scanning probe microscope apparatus of the embodiment according to the invention; and

FIG. 13 is a front view for explaining the method of removing the dust on the sample by the scanning probe microscope apparatus of the embodiment according to the invention.

### DETAILED DESCRIPTION OF THE PREFERRED EMBODIMENTS

An embodiment of the invention will be explained in reference to the drawings as follows.

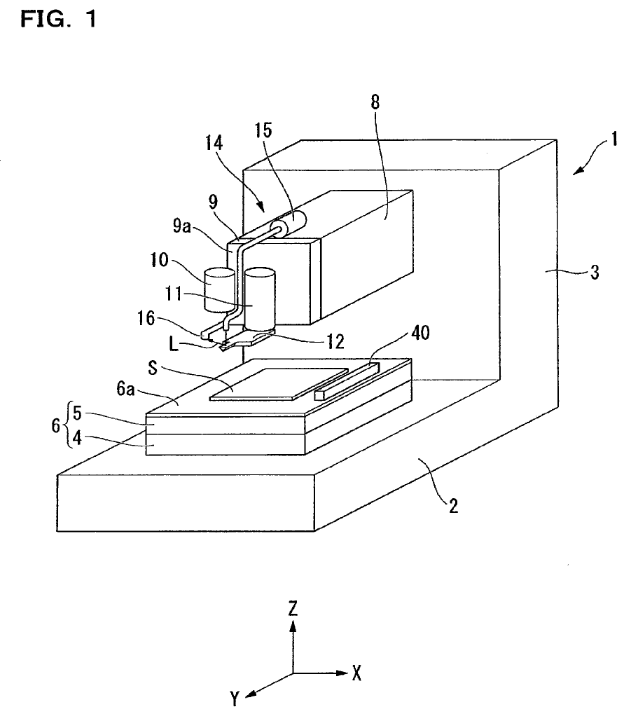

FIG. 1 is an outline perspective view of a scanning probe microscope apparatus of the embodiment. In the drawing, notation 1 designates a cabinet. The cabinet 1 is constituted by a base 2 and a side plate portion 3 attached to the base 2 in an erected state. A stage 6 having an X direction drive portion 4 and a Y direction drive portion 5 is attached onto the base 2. A sample S constituting an object of observing or working is fixed onto a sample base 6a of the stage 6.

A support arm 8 is extended from the side plate portion 3. A front end of the support arm 8 is provided with a Z direction drive portion 9. A moving plate 9a at a front end of the Z direction drive portion 9 is attached with an optical microscope 10 for observing the sample at a front end of a tweezers 12 mentioned later.

Further, the moving plate 9a is attached with a finely moving scanner 11 and an output portion of the finely moving scanner 11 is attached with the tweezers 12. The finely moving scanner 11 includes, for example, a piezoelectric element, and can finely be driven along directions of 3 axes of X and Y and Z by applying a voltage from an XYZ scanner control portion, not illustrated. Further, by the finely moving scanner 11, the tweezers 12 is made to move finely in the directions of 3 axis of X and Y and Z.

An upper side of the sample base 6a is provided with displacement measuring means 14 for measuring a displacement of the tweezers 12. The displacement measuring means 14 includes a laser light source 15 of irradiating laser light L to a reflecting face, not illustrated, formed on a side of a back face of the front end of the tweezers 12, and a light detecting portion 16 of receiving the laser light L reflected by the reflecting face by utilizing a mirror. The light detecting portion 16 is, for example, a photodiode an incident face of which is divided into 2 or divided into 4 for detecting a state of vibrating the tweezers 12 from an incident position of the laser light L. Further, the light detecting portion 16 outputs a detected displacement of the state of vibrating the tweezers 12 to a preamplifier as a DIF signal. Further, the DIF signal outputted from the light detecting portion 16 is amplified by the preamplifier, thereafter, transmitted to an alternating current-direct current converting circuit to be converted into a direct current, and transmitted to a Z voltage feedback circuit. The Z voltage feedback circuit subjects a finely moving scanner control portion to feedback control such that the DIF signal converted into direct current becomes always constant. Thereby, when the sample S on the sample base 6a is observed, a distance between the sample base 6a and the tweezers 12 can be controlled such that the state of vibrating the tweezers 12 becomes constant, specifically, an amount of attenuating an amplitude or an amount of deviating a frequency, or an amount of deviating a phase becomes constant.

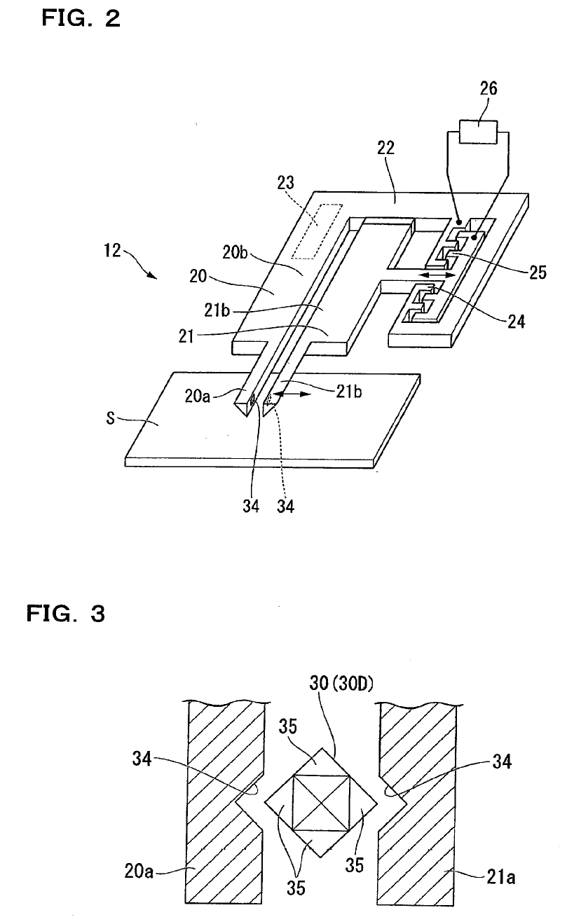

FIG. 2 is a perspective view showing a structure of the tweezers 12. As shown also in the drawing, the tweezers 12 is constituted by an observing arm 20 and a grasping arm 21 respectively having probes 20a and 21a arranged in adjacent with each other at a predetermined gap and disposed to the sample base 6a to be opposed to each other at front ends thereof. The both arms 20 and 21 which are formed of silicon, and supported by main body portions 20b, 21b fixed to a base portion 22 respectively in a cantilever state.

The observing arm 20 is fixed with a piezoelectric member 23 of vibrating the observing arm 20. The piezoelectric member 23 is made to be vibrated at a predetermined frequency and a predetermined amplitude by receiving a signal from a piezoelectric member control portion, and the vibration is transmitted to the observing arm 20. Thereby, the observing arm 20 is vibrated at the predetermined frequency and the predetermined amplitude similar to the piezoelectric member 23. That is, the piezoelectric member 23 and the piezoelectric member control portion constitute oscillating means.

The base portion 22 of the observing arm 20 is formed with combteeth 24 on one side. Combteeth 25 on other side are extended from the grasping arm 21 to be opposed to the combteeth 24. A direction of extending teeth of the combteeth 24 and 25 coincide with a direction of separating the two probes 20a and 21a of the tweezers. The two combteeth 24 and 25 are provided with electrodes and the electrodes are connected with a voltage apparatus 26 for combteeth for applying a voltage to the electrodes. By an amount of the voltage applied to the voltage apparatus 26 for combteeth, a clearance between the two combteeth 24 and 25, and therefore, a distance between the two probes 20a, 21a of the tweezers 12 are made to be adjusted.

At a front end of the tweezers 12, an interchanging work 30 (30A, 30B, 30C, 30D, 30E) is grasped. A plurality of kinds of the interchanging works 30 are prepared previously in accordance with object of use, the interchanging work 30 optimum for a corresponding operation is selected therefrom and grasped between the two probes 20a, 21a of the front ends of the tweezers 12. Also as shown in FIG. 1, the interchanging work 30 is held by a work holding base 31 attached onto the sample base 6a to provide a predetermined attitude. The tweezers 12, the interchanging work and the work holding base 31 constitute a tweezers system 32 for a scanning probe microscope.

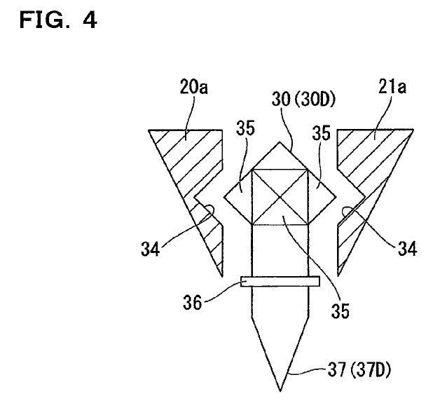

FIG. 3 and FIG. 4 are sectional views respectively showing a relationship between the tweezers 12 and the interchanging work 30. As shown by the drawings, engaging recess portions 34 in a shape of a quadrangular prism are formed at portions of the tweezers 12 brought into contact with the interchanging work 30, that is, inner side faces of the probes 20a, 21a of the two arms. On the other hand, engaging projected portions 35 in a shape of a quadrangular prism in correspondence with the engaging recess portions are formed at contact portions on an upper portion of the interchanging work 30 grasped by the tweezers 12, that is, side faces of the upper portion.

Further, a flange portion 36 is formed at a middle portion in a length direction of the interchanging work 30. The flange portion 36 is a portion supported in a state of being mounted on a work base 44 formed in a ring-like shape of the work holding base 31 when contained in a state of being supported by the work holding base 31. Further, a front end of the interchanging work 30 is provided with operating portions 37 (37A, 37B, 37C, 37D, 37E) of carrying out various operations by being brought into contact with a surface of the sample S when the sample S is observed or worked.

Here, a distance La from a center of the engaging projected portion 35 to a lower face of the flange portion 36, and a distance Lb from the center of the engaging projected portion 35 to the operating portion 37 are set to the same values in any of the interchanging works 30 (30A, 30B, 30C, 30D, 30E) mentioned later. Further, it corresponds similarly to any of the interchanging works 30 (30A, 30B, 30C, 30D, 30E) that a center of the operating portion 37 is disposed at a center of the interchanging work 30.

Therefore, when the interchanging work 30 supported by the work holding base 31 is grasped by the tweezers 12, when conversely, the interchanging work 30 is returned to the work holding base 31, or when the interchanging work 30 is grasped by the tweezers 12 to actually operate the sample S, the same procedures are carried out for any of the interchanging works 30.

Further, although according to the embodiment, the engaging recess portion 34 is constituted by the recess in the shape of the quadrangular prism, and the engaging projected portion 35 is constituted by the projected portion in the shape of the quadrangular prism in correspondence therewith, the embodiment is not limited thereto but the engaging recess portion 34 and the engaging projected portion 35 may be constituted by other shape, for example, a circular cone shape, a wedge shape, or a trapezoidal shape, in sum, there may be constructed a constitution in which the tweezers 12 and the interchanging work 30 can accurately be positioned by being engaged with each other at the centers.

Further, although in FIG. 3 and FIG. 4, the engaging projected portions 35 are provided respectively at 4 side faces of the upper portions of the interchanging work 30 at intervals of 90 degrees in a peripheral direction, the embodiment is not limited thereto but the engaging projected portions 35 may be provided only at 2 faces in parallel with each other which are brought into contact with the probes 20a and 21a of the tweezers 12.

Further, FIG. 3 and FIG. 4 show an example of using the cutting work 30D as an interchanging work.

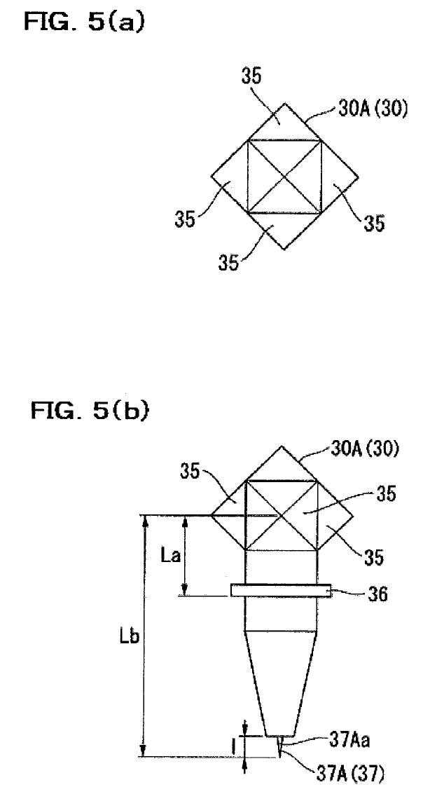

FIGS. 5A and 5B, FIGS. 6A and 6B, FIGS. 7A and 7B, FIG. 8 and FIGS. 9A and 9B respectively show examples of various interchanging works. In the drawings, common notations are attached to common constituent elements explained as described above.

FIG. 5A is a plane view of an observing stylus work, and FIG. 5B is a side view of the observing stylus work. The observing stylus work 30A performs scanning while being brought into contact along with a surface of the sample S. A front end of the operating portion 37A is formed with a needle-like portion 37Aa a length l of which is set to about 2 μm through 10 μm, and a top portion of the needle-like portion 37Aa is formed with a semicircular portion a radius of which is set to, for example, 5 nm through 50 nm.

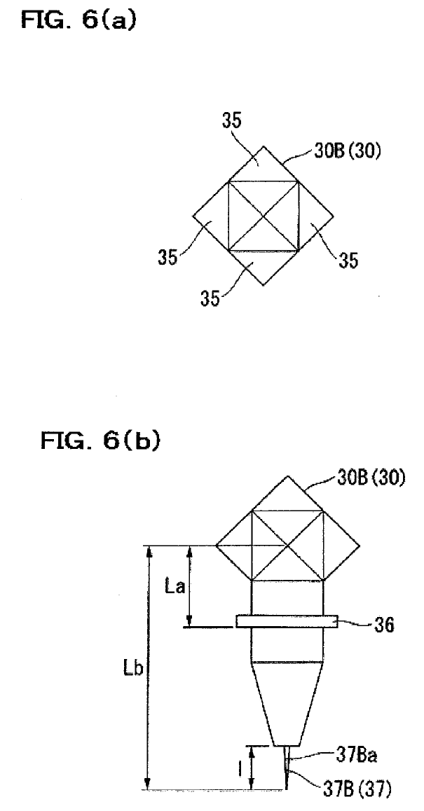

FIG. 6A is a plane view of a work for a contact hole, and FIG. 6B is a side view of the work for a contact hole. The work 30B for a contact hole is for raking out a dust at inside of a contact hole provided at the sample. A front end of the operating portion 37B is formed with a needle-like portion 37Ba a length l of which is set to about 100 nm to 500 nm, and a top portion of the needle-like portion 37Aa is constituted by an angular shape having a section in a square shape, a rectangular shape, or a rhombic shape, a side of which is set to about 20 nm through 50 nm. Further, the work 30B for the contact hole is made of a conductive material and can conduct electricity.

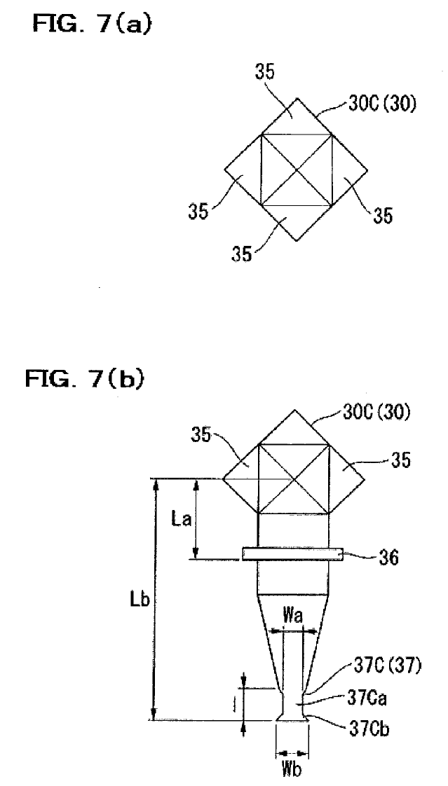

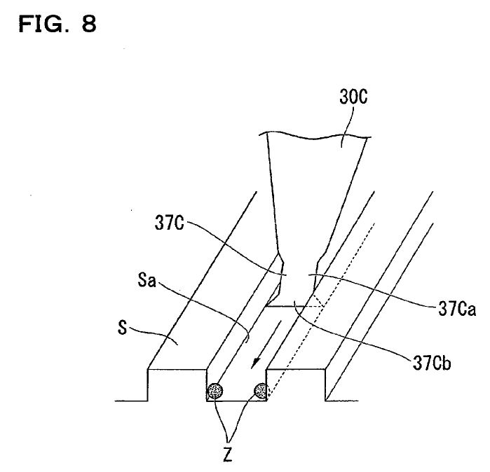

FIG. 7A is a plane view of a corner moving work, and FIG. 7B is a side view of the corner moving work. As shown by FIG. 8, the corner moving work 30C is for moving a dust Z disposed at a corner portion of a groove Sa provided at the sample. A front end of the operating portion 37C is formed with an angular shape slender diameter portion 37Ca a length l of which is set to 100 nm through 500 nm, and a side Wa of which is set to about 30 nm through 100 nm, and a top portion thereof is formed with an angular shape large diameter portion 37Cb one side Wb of which is set to, for example, about 50 nm through 300 nm.

Further, although FIG. 8 shows an example of simultaneously moving dusts Z respectively disposed at two left and right comers V of the groove Sa, the embodiment is not limited thereto but the corner moving work 30C is utilized even when only a dust disposed at either one of the left and right comers V of the groove Sa is moved.

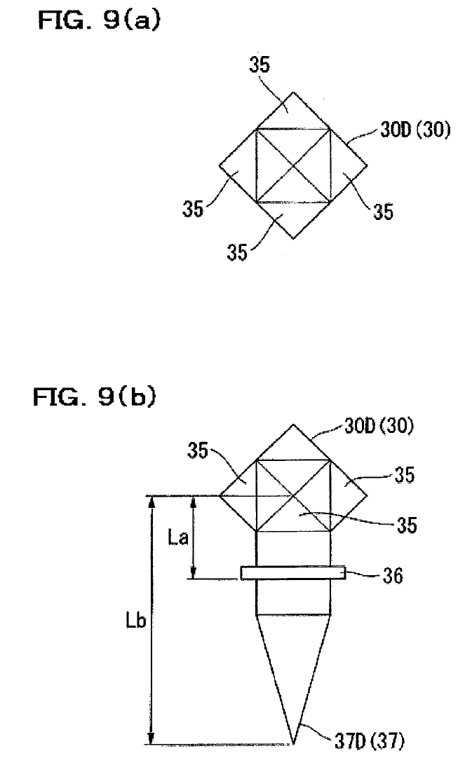

FIG. 9A is a plane view of a cutting work, and FIG. 9B is a side view of the cutting work. The cutting work 30D is for cutting (or polishing) a dust adhered to the sample S. The cutting work 30D is formed of silicon by including the operating portion 37C. A front end of the operating portion 37D is formed in a shape of a circular cone and a front end thereof is formed in a shape of a semicircle a radius of which is 5 nm through 50 nm. A top portion of a front end of the operating portion 37D is formed with a hard layer by coating diamond such that a radius thereof becomes 10 nm through 100 nm.

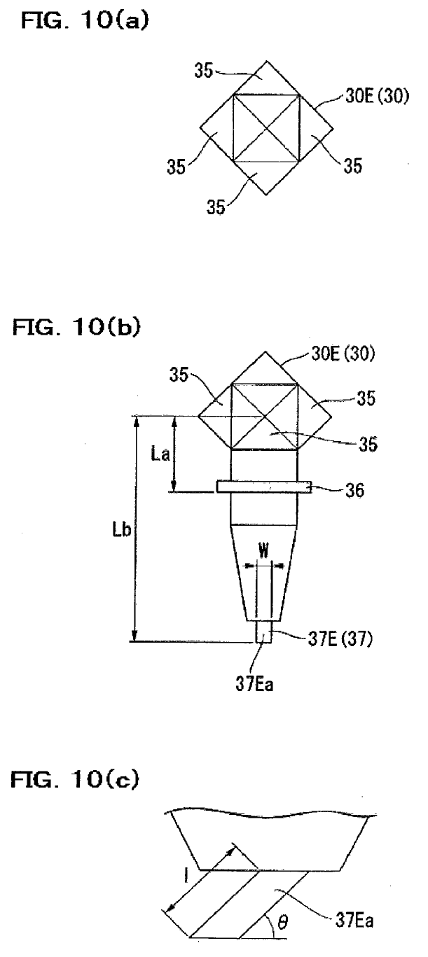

FIG. 10A is a plane view of a spatula shape work, FIG. 10B is a side view of the spatula shape work, and FIG. 10C is a side view enlarging a front end of the spatula shape work. The spatula shape work 30E is for moving a dust adhered to the sample. The operating portion 37E is attached with a spatula shape portion (rectangular parallelepiped shape) 37Ea a length l of which is set to 100 nm through 500 nm and a width W of which is set to 50 nm through 300 nm to be inclined skewedly. An angle of inclination θ of the spatula shape portion 37Ea is set to 30 degrees through 60 degrees.

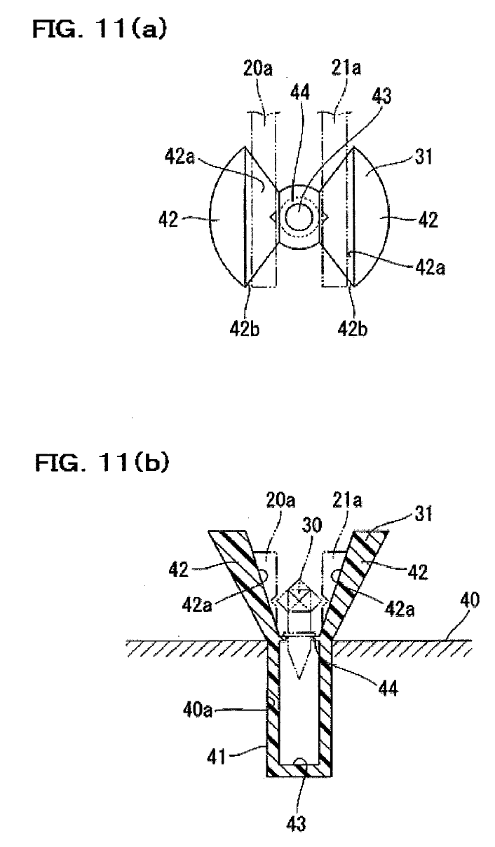

FIG. 11A is a plane view of the work holding base, and FIG. 11B is a sectional view of the work holding base. As shown by the drawings, the work holding bases 31 are attached onto a common base 40 attached to the sample base 6a as shown by FIG. 1 and FIG. 11A and 11B at predetermined intervals. The work holding base 31 includes a bottomed cylinder portion 41 fitted into a hole 40a formed at the common base 40, and left and right wing portions 42, 42 attached to the upper portion of the cylinder portion 41. According to the cylinder portion 41, a space at inside thereof constitutes a work containing hole 43 for containing the work, and an upper end thereof is formed with a work base 44 in a ring-like shape as described above. Further, an angle of inclination of inner side faces 42a, 42a of the left and right wing portions 42, 42 is set to a value substantially the same as that of the angle of inclination of the outer side faces of the probes 20a and 21a of the tweezers. Further, as shown by FIG. 11A, a size of the left and right wing portions 42, 42 is set such that when the front ends of the probes of the tweezers are made to coincide with side edges 42b, 42b of the left and right wing portions, a line of connecting centers of the left and right engaging recess portions 34 of the probes coincides with the center of the work holding base 31.

Therefore, the probes 20a and 21a of tweezers are guided to the inner side faces 42a, 42a of the left and right wing portions such that the engaging projected portion 35 of the interchanging work 30 and the engaging recess portion 34 of the tweezers 12 are disposed at positions of being engaged with each other when the tweezers 12 is set to a predetermined opening angle and is made to be proximate to the work holding base 31 in a state of holding the interchanging work 30 at the work holding base 31. That is, the inner side faces 42a, 42a of the left and right wing portions constitute guide portions of guiding the tweezers 12 such that the engaging projected portions 35 and the engaging recess portions 34 are engaged with each other.

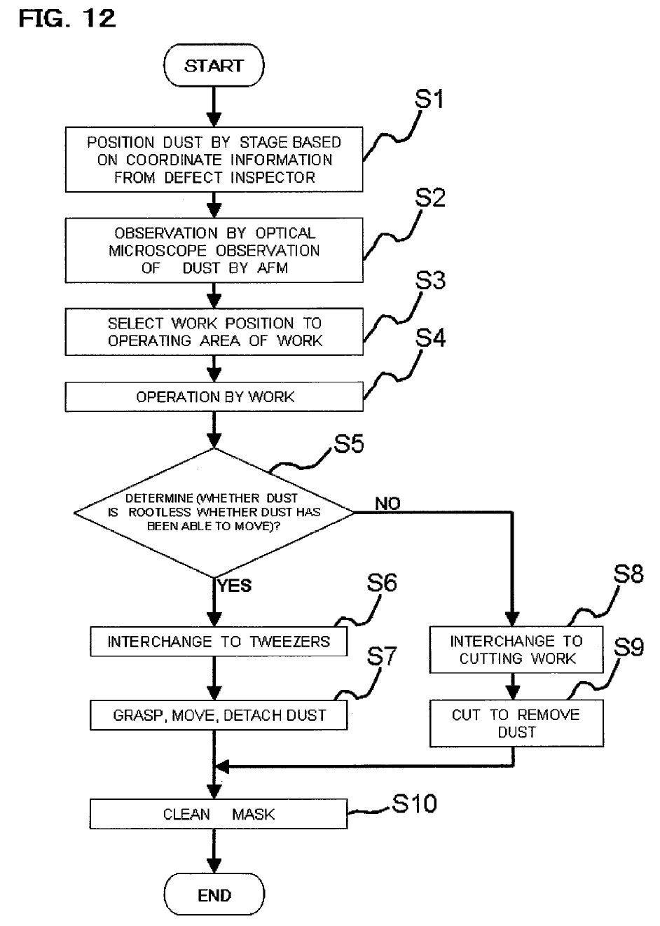

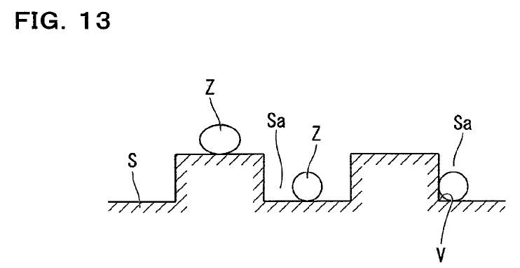

Next, an explanation will be given of a method of removing a dust on a sample by using the scanning probe microscope apparatus in reference to FIG. 12 and FIG. 13.

The sample S provided with information of presence of a dust by a defect inspector is fixed to a predetermined position on the sample base 6a. Further, the X direction drive portion 4 and the Y direction drive portion 5 and of stage 6 are respectively driven such that the front end of the tweezers 12, further specifically, the stylus 20a of the observing arm coincides with a portion on the sample S at which the dust is present based on coordinates information with regard to the dust previously provided from the defect inspector (step S1).

Next, information with regard to dust Z (for example, shape or the like of dust Z) is provided by observing by the optical microscope 10. When the observation cannot be carried out by the optical microscope 10, observation by SEM or AFM may be carried out by a function incorporated in the scanning probe microscope apparatus (step S2).

At this occasion, the observing stylus work 30A may be grasped by the front end of the tweezers 12, and the dust Z with regard to the sample S may be observed by the observing stylus work 30A. Further, a method of grasping the observing stylus work 30A by the tweezers 12 will be explained later in details.

Next, the interchanging work 30 is selected in accordance with a shape of the dust Z or a situation of adhering the dust Z to the sample S based on a result of the observation (step S3). As a reference of selecting the interchanging work, for example, when the dust invades inside of a contact hole, the work 30B for the contact hole shown in FIG. 6 is selected. As shown by FIG. 13, when the dust Z is adhered to the corner portion V of the groove Sa, the corner moving work 30C shown in FIG. 8 is selected. When the dust invades inside of the groove Sa and the dust is constituted by a powder shape, the work 30E of the spatula shape is selected.

When selection of the interchanging work is determined, by driving the stage 6, the front end of the tweezers 12 is relatively moved to the work holding base 31 of holding the selected interchanging work. Further, by adjusting an amount of the voltage applied to the voltage apparatus 26 for the combteeth, the clearance between the probes 20a and 21a of the front end of the tweezers is expanded to a size capable of grasping the interchanging work 30. Thereafter, the probes 20a and 21a of the front end of the tweezers are brought into contact with the inner side faces 42a, 42a of the left and right wing portions of the work holding base 31, and the tweezers 12 is moved down under the state. The probes 20a and 21a of the tweezers are moved down by being guided by the inner side faces 42a, 42a of the left and right wing portions of the work holding base 31 and the tweezers 12 is made to stop moving down when the engaging recess portion 34 of the probes 20a and 21a of the tweezers come to a height position of the engaging projected portion 35 of the interchanging work 30. Next, the amount of voltage applied to the voltage apparatus 26 for the combteeth is adjusted again, the clearance between the probes 20a and 21a of the front end of the tweezers is narrowed to grasp the interchanging work 30.

At this occasion, the engaging recess portions 34 of the probes 20a and 21a of the tweezers are engaged with the engaging projected portions 35 of the interchanging work 30, and therefore, a state of locking the tweezers 12 and the interchanging work 30 is uniquely determined and relative positions of the probes 20a and 21a of the tweezers and the operating portion 37 of the interchanging work remain unchanged even when any of the interchanging works 30 is grasped.

Next, the operating portion 37 of the front end of the interchanging work 30 grasped by the tweezers 12 is positioned to an area at which the dust Z of the sample S is present by driving the stage 6 (step S3).

Thereafter, the operating portion 37 of the interchanging work is moved while being brought into contact with the predetermined region of the sample S and a predetermined operation is carried out by the operating portion 37 of the interchanging work. Specifically, the dust is moved, or the moved dust is attracted to the interchanging work by an electrostatic operation (step S4). In FIG. 13, the dust Z disposed at the center is constituted by moving the dust Z inherently disposed at the corner portion V of the groove Sa.

Next, the operated dust Z is observed by the optical microscope 10 or SEM or AFM to determine whether the dust is rootless, in other words, whether the dust has been able to be moved. (step S5).

When it is determined that the dust has been able to be moved, the interchanging work 30 is detached from the tweezers 12 (step S6), the dust Z moved by the tweezers 12 is grasped and the dust Z is moved to a predetermined portion (step S7). That is, in FIG. 13, with regard to the dust Z moved to the center of the groove Sa, when the front end of the tweezers can be inserted into the groove, the dust Z can easily be grasped. Further, with regard to the dust disposed at the surface of the sample inherently as on the left side of FIG. 13, the dust can be grasped directly by the tweezers 12 to move without moving the dust by the interchanging work 30 or the like.

On the other hand, when it is determined that the dust cannot be moved at the step S5, the interchanging work 30 grasped at the front end of the tweezers 12 is interchanged from the interchanging work for moving the dust to the cutting work 30D. Specifically, the tweezers 12 is relatively moved to the common base 40, the grasped interchanging work 30 is returned to the work holding base 31 which does not hold the interchanging work. Successively, the tweezers 12 is relatively moved again to be opposed to the work holding base 31 holding the cutting work 30D. Further, the cutting work 30D is grasped by the tweezers 12 by repeating the above-described operation again (step S8).

Next, the tweezers 12 is relatively moved to the sample S up to position at which the cutting work 30D grasped by the tweezers 12 is opposed to the dust, the cutting work 30D is vibrated in a state of being brought into contact with the dust or the surface of the sample at a vicinity of the dust to cut to remove the dust (step S9).

Next, the dust is completely removed by being processed by a cleaning step in a publicly-known photolithography technology (step S10).

Further, the above-described embodiment is persistently an exemplification of the invention and can pertinently be changed in design thereof within a range not deviated from the gist of the invention.

Although the embodiment shows an example of utilizing the tweezers system for the scanning probe microscope and the scanning probe microscope apparatus of the invention when the dust on the surface of the sample is removed, the invention is not limited thereto but is applicable also in a case of carrying out an operation for other use, for example, an operation of piercing, an operation of cutting, or an operation of grasping a living body.

Further, although according to the embodiment, as examples of interchanging works, the observing stylus work 30A, the work 30B for the contact hole, the corner moving work 30C, the cutting work 30D, the spatula shape work 30E are pointed out, the invention is not limited thereto but other interchanging work may be used.

Further, although according to the embodiment, all of the exemplified interchanging works 30 are prepared on the work holding base 31, it is not necessary to prepare all of them but only 2 kinds or 3 kinds thereof may be prepared.

What is claimed is:

1. A tweezers system for a scanning probe microscope comprising:
a tweezers comprising two arms having probes arranged opposedly to a sample and integrated to a scanning probe microscope and constituting an object of observation or working respectively at front ends thereof; and
a plurality of kinds of interchanging works one of the plurality of kinds of which is selectively grasped by the tweezers.

2. The tweezers system for a scanning probe microscope according to claim 1, wherein as the plurality of kinds of interchanging works, there are provided at least two kinds of interchanging works of an observing stylus work scanned along a surface of the sample, a work for a contact hole of raking out a dust at inside of a contact hole of the sample, a corner moving work of moving the dust disposed at a corner portion of the sample, a cutting work of cutting the dust adhered to the sample, and a spatula shape work of moving the dust disposed at a groove of the sample.

3. The tweezers system for a scanning probe microscope according to claim 1, wherein an engaging projected portion is provided at one of portions of the tweezers and the interchanging work brought into contact with each other and an engaging recess portion is provided at other thereof; and
wherein by engaging the engaging projected portion and the engaging recess portion, when the interchanging work is grasped by the tweezers, positioning of the engaging projected portion and the engaging recess portion is carried out.

4. The tweezers system for a scanning probe microscope according to claim 3, wherein the engaging projected portions or the engaging recess portions respectively provided at base end sides thereof and operating portions provided at front end sides thereof for carrying out observation or working by being brought into contact with a sample are set to the same positional relationship.

5. The tweezers system for a scanning probe microscope according to claim 3, further comprising:
a work holding base having a guide portion holding the interchanging work at a predetermined position and guiding the tweezers such that the engaging projected portion and the engaging recess portion are engaged with each other when the tweezers is proximate thereto.

6. A scanning probe microscope apparatus, wherein the scanning probe microscope apparatus comprises the tweezers system for a scanning probe microscope according to claim 1.

7. A method of removing a dust which is a method of removing a dust of removing a dust on the sample by using the scanning probe microscope apparatus according to claim 6, the method comprising:
a step of observing a shape of a predetermined area of the sample by the tweezers or the interchanging work attached to the tweezers;
a step of determining the interchanging work suitable in working the sample from an observation image acquired by the step and attaching the interchanging work to the tweezers; and
a step of removing the dust on the sample by working the sample by the attached interchanging work.
